(19) United States
(12) Patent Application Publication
(10) Pub. No.: US 2017/0356529 A1
(43) Pub. Date: Dec. 14, 2017

(54) VARIABLE FORCE TENSIONING ASSEMBLY

(71) Applicant: BorgWarner Inc., Auburn Hills, MI (US)

(72) Inventor: Sean R. SIMMONS, Ithaca, NY (US)

(21) Appl. No.: 15/617,267

(22) Filed: Jun. 8, 2017

Related U.S. Application Data
(60) Provisional application No. 62/349,267, filed on Jun. 13, 2016.

(51) Int. Cl. F16H 7/08

(52) U.S. Cl. CPC F16H 7/0848; F16H 2007/0859; F16H 2007/0893; F16H 2007/0812; F16H 2007/0872; F16H 2007/0897; F16H 2007/0855; F16H 2007/0806

(57) ABSTRACT

A variable force tensioning assembly creates and maintains a tension force on an endless loop used to transmit power. The variable force tensioning assembly includes a body having a cylinder defining a cylinder inner diameter. An outer piston is disposed substantially within the cylinder and slidable therewithin. The outer piston includes an outer piston tube and a chamber divider extending through the outer piston tube. The outer piston and the body define a low rate portion. An inner piston is disposed at least partially within the outer piston tube and is slidable therewithin. The inner piston defines a high rate portion and acts with the outer piston against the body to create a variable force to push against the endless loop to maintain a constant tension in the endless loop.

### CROSS-REFERENCE TO RELATED APPLICATION

This application claims benefit of U.S. Provisional Application Ser. No. 62/349,267 filed Jun. 13, 2016, the disclosure of which is herein incorporated by reference in its entirety.

### BACKGROUND

The invention relates to a variable force tensioning assembly for use in conjunction with an endless, flexible, power transmission member. More particularly, the invention relates to a variable force tensioning assembly that maintains a constant tension force on an endless, flexible, power transmission member such as a timing belt or a timing chain, encircling a drive sprocket and at least one driven sprocket used for an internal combustion engine of a motor vehicle.

A tensioner for an endless loop, such as a timing belt or a timing chain, is used to control the endless loop as the endless loop travels around a plurality of sprockets or gears. The slack of the endless loop varies as the temperature in the engine increases and as the endless loop wears. When wear occurs, the endless loop elongates and the slack in the endless loop increases. The increase in slack may cause noise, slippage, or, in the case when the endless loop is a chain, tooth jumping between the chain and sprocket teeth. If the increase of the slack in the endless loop is not taken up, by a tensioner for example, in an engine that uses the endless loop to drive a camshaft, the engine may be damaged because the camshaft timing will be misaligned by several degrees due to the slippage or tooth jumping.

In the case when a hydraulic tensioner is used, the performance of the hydraulic tensioner is based on two primary functions of a check valve. First, oil must flow through a check valve and into a high pressure chamber of the tensioner as the piston extends to take up slack in the endless loop. If the flow restriction of the check valve is too great, the piston will not have enough oil volume to support its extended length. Secondly, as the endless loop begins to push the piston back into the tensioner, the oil wants to flow back out of the check valve. At this point, the check valve ball must move back to seal off the oil passage. If the response time is slow, it takes longer to build up the necessary pressure to support the piston and control of the tension in the endless loop becomes an issue.

### SUMMARY

A variable force tensioning assembly creates and maintains a tension force on an endless loop used to transmit power. The variable force tensioning assembly includes a body having a cylinder. An outer piston is disposed substantially within the cylinder and slidable therewithin. The outer piston includes an outer piston tube and a chamber divider extending through the outer piston tube. The outer piston and the body define a low rate portion. An inner piston is disposed at least partially within the outer piston tube and is slidable therewithin. The inner piston defines a high rate portion and acts with the outer piston against the body to create a variable force to push against the endless loop to maintain a constant tension in the endless loop.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a simplified schematic of a variable force tensioning assembly according to one embodiment of the invention for an endless loop used as a power transmission member for an internal combustion engine;

FIG. 2 is a perspective view, partially cutaway, of one embodiment of the invention;

FIG. 3 is a cross-sectional side view of the embodiment shown in FIG. 2;

FIG. 4 is a cross-sectional side view of an alternative embodiment of the invention;

FIG. 5 is a partial cross-sectional side view of the embodiment in FIG. 4 with a ratchet clip allowing a lower force to move the piston assembly out and away from the body;

FIG. 6 is a cross-sectional partial side view of the embodiment of FIG. 4 with a ratchet clip seated, preventing an inward stroke of the piston without receiving a greater force on the piston; and

FIG. 7 is an exploded perspective view of the alternative embodiment.

### DETAILED DESCRIPTION

The term “loop,” “belt” or “chain,” as used interchangeably herein, is any power transmission member forming an endless loop and constructed of flexible material or of articulated rigid lengths to permit the member to conform to a radius of curvature of a pulley or sprocket drive face and intended, in use, to be driven in an endless path; and, by contact with the pulley or sprocket drive face, to transmit power to or extract power from the pulley or sprocket. The term “pulley” or “sprocket” as used interchangeably herein, is a device rotatable about an axis and having a drive face radially spaced from the axis of rotation for intended power transferring engagement with a belt or chain to drive the belt or chain on an endless path or to extract power from the belt or chain to drive an output load device. The term “guide roll” as used herein is a device rotatable about an axis and having a belt or chain-contacting face radially spaced from the axis of rotation for intended engagement with the belt or chain to aid in directing the belt or chain along an intended path of travel. A guide roll, as distinguished from a pulley or sprocket, is not intended to provide driving power to, or extract power from, a belt or chain. The term “tensioning arm” as used herein is a member other than a pulley or sprocket engagable with the belt or chain, and which is adjustable or relatively movable with respect to the belt or chain in a direction which causes an increase or decrease in tensile stress in the belt or chain or a take-up of any undesirable belt or chain slack to maintain a desirable drive traction between the belt or chain and the pulley or sprocket drive face. A tensioning arm, as distinguished from a guide roll, has a non-rotatable face portion for contacting the belt or chain, whereby the belt or chain slides over the face portion of the tensioning arm. The term “hydraulic tensioner” as used herein applies to a force for actuating the tensioning arrangement and is derived from or transmitted via the exertion of force on a fluid.

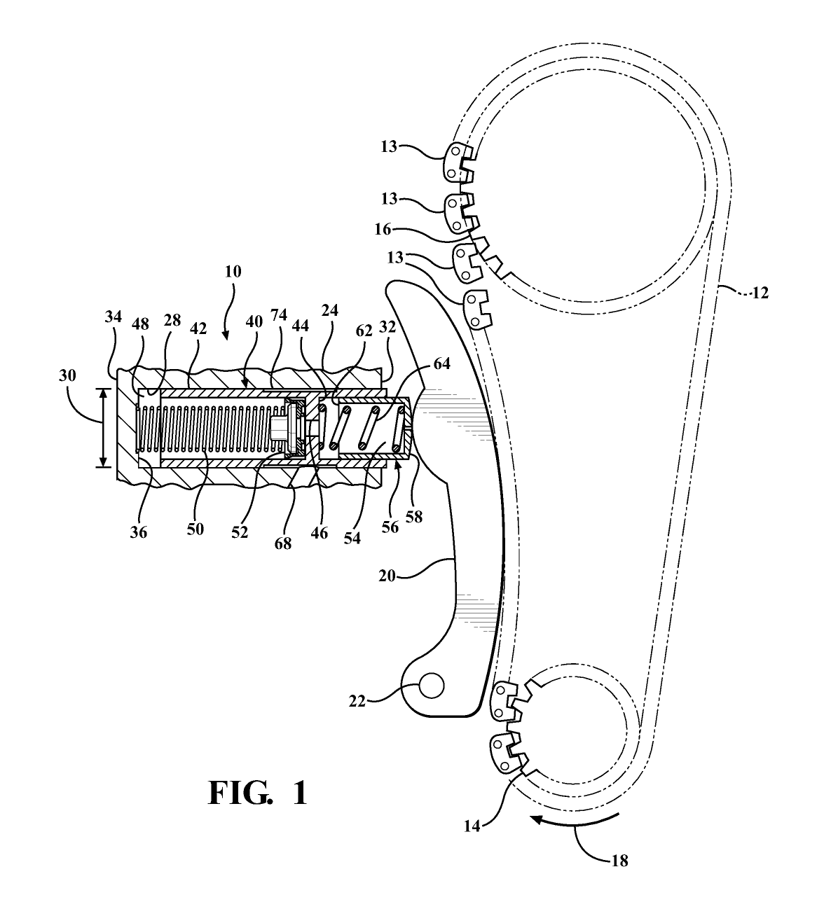

Referring to FIG. 1, a variable force tensioning assembly is generally indicated at 10. The variable force tensioning assembly 10 is schematically illustrated as a hydraulic tensioner used in conjunction with an endless loop, flexible, power transmission member 12 (“endless loop 12”) for an internal combustion engine of a motor vehicle (neither the internal combustion engine nor the motor vehicle are shown). The endless loop 12 is shown as a chain having links 13 that encircles a drive sprocket 14 driven by a driveshaft, such as a crankshaft of the internal combustion engine, and at least one driven sprocket 16 supported from a driven shaft, such as a camshaft of the internal combustion engine. A guide roll can also be provided, if desired. The endless loop 12 passes over the drive sprocket 14 and driven sprocket 16 when driven in rotation as shown by arrow 18. At least one tensioning arm 20 is positioned with a face assembly including a shoe for sliding engagement with the endless loop 12. The tensioning arm 20 may pivot about pivot 22 in response to a force exerted by the variable force tensioning assembly 10. By applying a force in a clockwise direction when viewing FIG. 1, the tensioning arm 20 pivots about the pivot 22 and applies tension to the endless loop 12 to remove excess slack. It should be recognized that the variable force tensioning assembly 10 disclosed below can be used in other alternative configurations of tensioning arms without departing from the spirit or scope of the invention, and that the illustrated configuration is by way of example only, and is not to be considered a limitation of the invention.

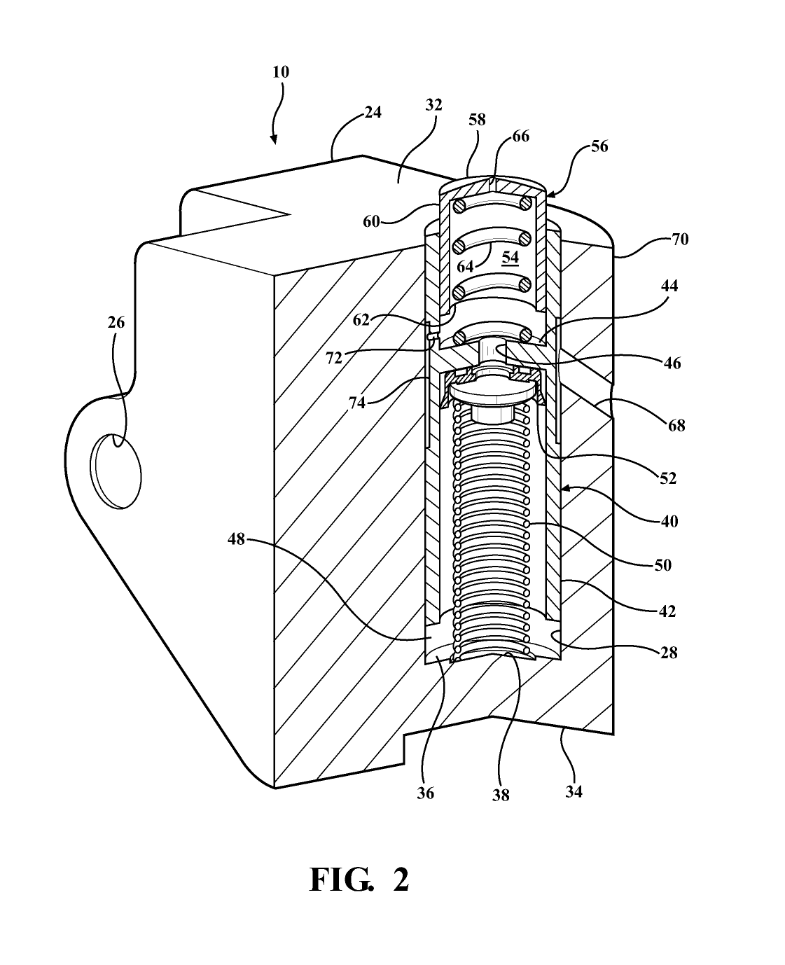

Referring to FIGS. 1 through 3, the variable force tensioning assembly 10 includes a body 24. The body 24 includes at least one aperture 26 that allows a fastener (not shown) to secure the body 24 to a portion of the motor vehicle such that the variable force tensioning assembly 10 will be disposed adjacent the tensioning arm 20 and, as such, operatively engageable with the endless loop 12. The body 24 defines a cylinder 28, which defines a cylinder inner diameter 30 (shown graphically in FIG. 1). The cylinder 28 is open at a tension arm facing surface 32 of the body 24 and is closed at a non-facing surface 34. Because it is closed, the cylinder 28 defines an abutment surface 36 that extends perpendicular to the cylinder 28 along the non-facing surface 34. In the embodiment shown, the abutment surface 36 includes a spring relief 38, which receives a spring (discussed subsequently) therein.

The variable force tensioning assembly 10 also includes an outer piston, generally shown at 40. The outer piston 40 is disposed substantially within the cylinder 28 of the body 24 and is slidable therewithin. The outer piston 40 includes an outer piston tube 42 and a chamber divider 44. The chamber divider 44 extends through the outer piston tube 42. In the embodiment shown, the chamber divider 44 extends perpendicularly to the outer piston tube 42 and parallel to the abutment surface 36 of the cylinder 28. In the embodiment shown in the Figures, the outer piston tube 42 has a circular cross section. It should be appreciated by those skilled in the art that the outer piston tube 42 may have a cross sectional shape other than a circle without deviating from the concepts of the invention. The chamber divider 44 includes chamber passage 46. In the examples shown in FIGS. 1 through 3 the chamber passage 46 is a fluid passage. The space between the outer piston tube 42, the chamber divider 44 and the abutment surface 36 of the cylinder 28 defines a chamber described as a low rate portion 48. The low rate portion 48 receives fluid therein and houses a low rate spring 50. The low rate spring 50 takes up any elongation in the endless loop 12 by asserting a force against the tensioning arm 20, which is translated into reduced slack in the endless loop. A check valve 52 is disposed between the chamber divider 44 and the low rate spring 50. The check valve 52 selectively opens and closes the chamber passage 46 based on the pressures of the fluids within the low rate portion 48 and a high rate portion 54, discussed subsequently. The check valve 52 also releases air from the low rate portion 48, if necessary.

The variable force tensioning assembly 10 also includes an inner piston 56 disposed substantially within the outer piston tube 42 and slidable therewithin. The inner piston 56, together with the portion of the outer piston tube 42 between the tension arm facing surface 32 and the chamber divider 44 defines a chamber described as a high rate portion 54. It is the inner piston 56 that acts, in conjunction with the outer piston 40, against the body 24 to create a variable force to push against the endless loop 12 vis-a-vis the tensioning arm 20 to maintain a constant tension in the endless loop 12. The inner piston 56 includes a cap surface 58, which abuts the tensioning arm 20, and an inner cylinder 60 having an open end 62 disposed adjacent the chamber divider 44. In addition to the fluid which is received by the inner piston 56, a high rate spring 64 is disposed within the inner piston 56 between the cap surface 58 and the chamber divider 44. The inner piston 56 is slidable with respect to the outer piston 40. A small air vent 66 allows air to escape the high rate portion 54.

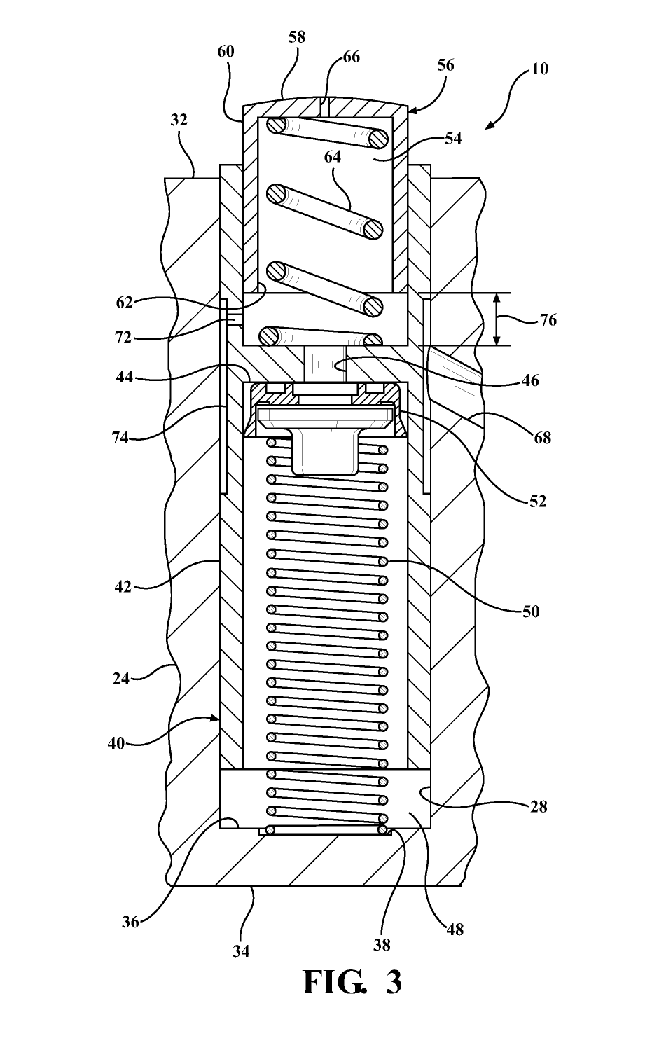

A fluid inlet passage 68 extends between an outer surface 70 of the body 24 and the cylinder 28. The fluid inlet passage 68 is the passageway through which the fluid, typically a hydraulic oil, is delivered to the cylinder 28 as well as into the low rate portion 48 and the high rate portion 54. As is shown best in FIG. 3, the fluid reaches the high rate portion 54 through a chamber passage 72 cut through the outer piston tube 42 near the chamber divider 44 but within the high rate portion 54. The chamber passage 72 is selectively closed when the inner piston 56 is forced down into the high rate portion 54. When this happens, the high rate portion 54 provides the hydraulic fluid to the low rate portion when the engine cannot supply oil to the variable force tensioning assembly 10 due to the fact that the chamber passage 72 has been closed by the inner cylinder 60 of the inner piston 56. Assisting in the transfer of the hydraulic fluid from the fluid inlet passage to the high rate portion 54 is an outer surface relief 74. The outer surface relief 74 is a portion of the outer piston tube 42 that has a diameter that is less than the cylinder diameter 30. This creates a passageway through which the fluid can pass from outside the body 24 into the cylinder 28 and the inner 56 and outer 40 pistons via the chamber passage 72.

The clearance 76 between the open end 62 of the inner cylinder 60 and the chamber divider 44 controls the stroke of the piston as the endless loop 12 provides a force on the variable force tensioning assembly 10 vis-à-vis the tensioning arm 20.

When an input force is received by the endless loop 12 forcing the compression of the variable force tensioning assembly 10, the inner 56 and outer 40 pistons compress or reduce the volume inside the low rate 48 and high rate 54 portions. The fluid in the low rate chamber 48 flows out due to its decreasing volume. The reservoir provides fluid to the low rate chamber 48 using negative pressure upon its return to a larger volume. Generally, the low rate chamber 48 keeps enough fluid therein to generate a reaction force when necessary.

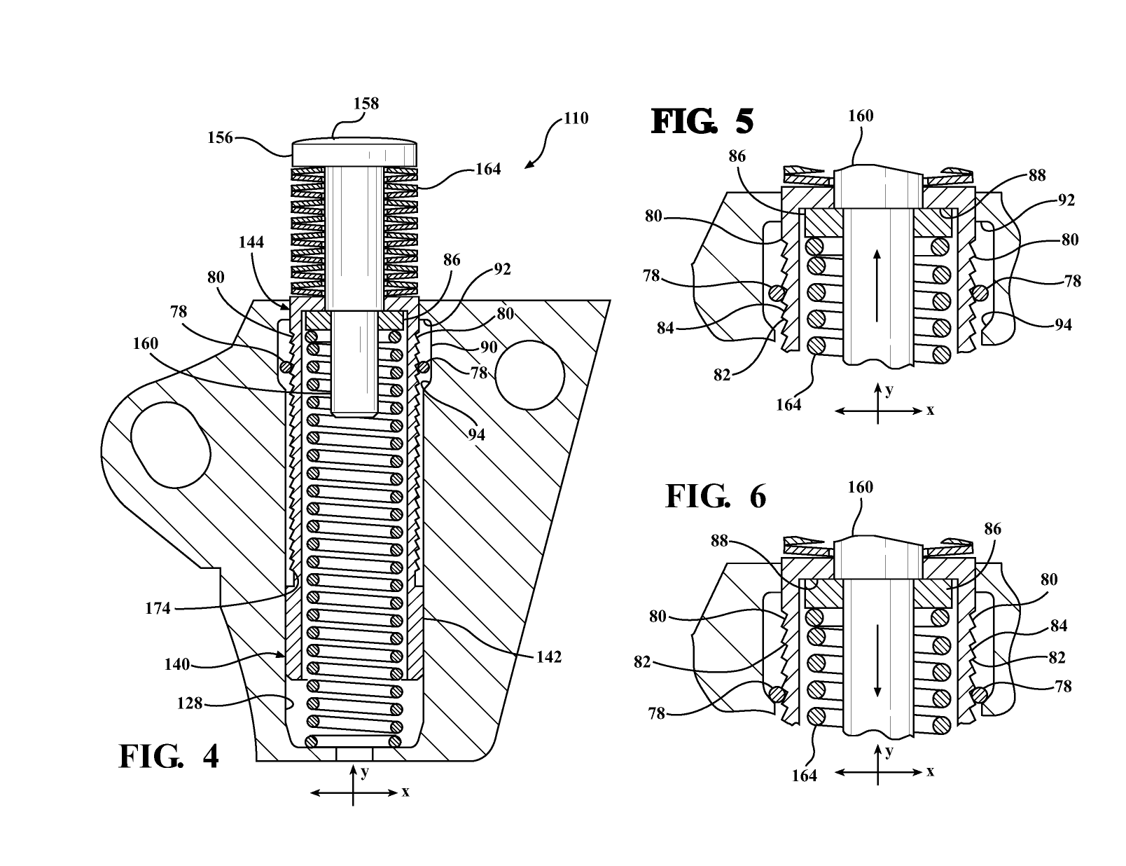

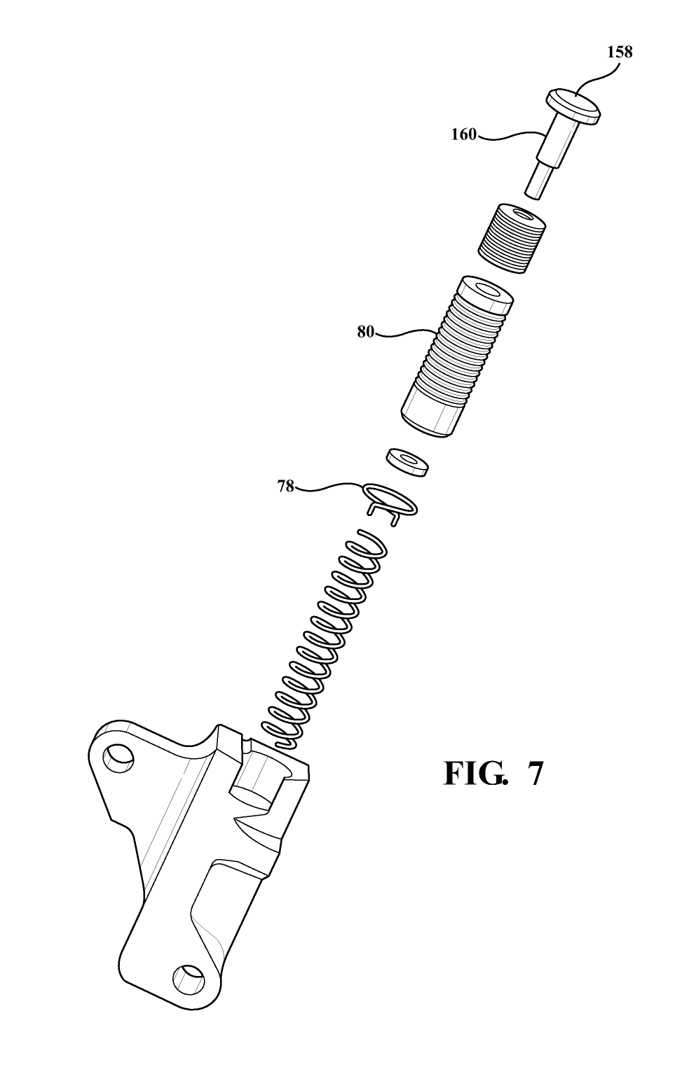

An alternative embodiment to the variable force tensioning assembly 110 is shown in FIGS. 4 though 7, wherein like elements similar to those disclosed in the first embodiment in FIGS. 1 through 3 include reference numerals similar to those shown in the first embodiment with an offset of 100. The description of these elements in the first embodiment are hereby incorporated into the alternative embodiment.

In the alternative embodiment, the variable force tensioning assembly 110 is not a hydraulic assembly. In the place of hydraulics is a ratchet and retainer. Because this embodiment does not incorporate the use of hydraulics, elements such as the check valve 52, small air vent 66, fluid inlet passage 68, and chamber passage 72 are not required. In place of the hydraulics is a ratchet clip 78 and a plurality of ribs 80 that encircle the outer surface relief 174 of the outer piston tube 142. Each of the plurality of ribs 80 includes a shallow side 82 and a steep side 84. That is, the ratio of displacement of the ratchet clip 78 as is moves along the shape of the shallow side 82 is further in the x-direction relative to displacement in the y-direction than occurs when the clip 78 moves along the steep side 84. The ratchet clip 78 is slidably securable to the outer piston 140 and slidable along the plurality of ribs 80 rendering forces required to move the inner piston 156 into the cylinder 128 greater than the forces required to move the inner piston 156 out of the cylinder 128. The variable force tensioning assembly 110 also includes a retaining ring 86.

In this embodiment, the inner piston 156 includes a solid inner cylinder 160 or inner stem 160. The inner cylinder 160 extends through the high rate spring 164 and is retained in place by the retainer ring 86 which is disposed on an inner side 88 of the chamber divider 144. The high rate spring 164 may be implemented using a plurality of disk-shaped springs that collectively act against the inner piston 156. The disk-shaped springs, sometimes referred to as Belleville washers or spring washers, can be oriented in series by stacking the springs on top of each other in an axially-aligned orientation. Or the disk-shaped springs can be arranged in parallel such that the center line of one disk-shaped spring is offset from another disk-shaped spring. And rather than a single module of disk-shaped springs arranged in parallel or series, multiple modules each comprising a plurality of disk-shaped springs may be used. It should be understood that the number of disk-shaped springs used to implement the high rate spring 164 can be selected based on a desired spring rate for the high rate spring 164. The quantity, orientation, and/or the size of the disk-shaped springs used to implement the high rate spring 164 can be selected to make the overall stiffness of the spring 164 progressive or regressive. The cap surface 158 is fabricated of a solid material and does not include a small air vent similar to the small air vent 66 found in the first embodiment. Because this embodiment does not include hydraulic fluid, there is no reason to vent air out from the system. The retainer ring 86 is press fit over the inner cylinder 160 to secure the inner piston 156 to the outer piston 140.

The cylinder 128 includes a relief 90 that extends along a portion of the cylinder 128. The relief 90 provides first 92 and second 94 stops preventing the ratchet clip 78 from moving therepast. The first stop 92 prevents the outer piston 140 and the inner piston 156 from leaving the body 124 of the variable force tensioning assembly 110.

Referring to FIG. 5, the ratchet clip 78 is not seated against either of the first 92 or second 94 stops. As the inner piston 156 moves out and away from the cylinder 128, a lower force is required and low stiffness providing minimal damping occurs. This is to move the inner piston 156 out allowing the tensioning arm 20 to engage the endless loop 12 quickly. In FIG. 6, the ratchet clip 78 is seated against the second stop 94. When this occurs, a higher force is required to move the inner piston 156 back into the cylinder 128 and body 124. Because the ratchet clip 78 abuts the second stop 94 and is seated, a higher force is required to overcome the steep sides 82 of the plurality of ribs 80. This provides a high stiffness and the maximum amount of damping so that tension arm 20 does not readily retract with respect to the endless loop 12 such that a force is maintained on the endless loop 12 in a manner to provide smooth transitions between periods of slack and periods of tautness.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A variable force tensioning assembly for creating and maintaining a tension force on an endless loop used to transmit power, the variable force tensioning assembly comprising:
a body having a cylinder;
an outer piston disposed substantially within the cylinder and slidable therewithin, the outer piston including an outer piston tube and a chamber divider extending through the outer piston tube, the outer piston and the body defining a low rate portion; and
an inner piston disposed at least partially within the outer piston tube and slidable therewithin, the inner piston defining a high rate portion and acting with the outer piston against the body to create a variable force to push against the endless loop to maintain a constant tension in the endless loop.

2. A variable force tensioning assembly as set forth in claim 1 wherein the outer piston includes an outer surface relief extending along a portion of the outer piston tube.

3. A variable force tensioning assembly as set forth in claim 2 including a fluid inlet extending through the body and opening into the cylinder to provide fluid to the high rate portion.

4. A variable force tensioning assembly as set forth in claim 3 including a check valve disposed inside the low rate portion to inhibit fluid flow between the low and high rate portions.

5. A variable force tensioning assembly as set forth in claim 4 wherein the chamber divider includes a chamber passage extending therethrough providing fluid communication between the high and low rate portions.

6. A variable force tensioning assembly as set forth in claim 2 including a low rate spring extending through the low rate portion between the body and the chamber divider.

7. A variable force tensioning assembly as set forth in claim 6 including a high rate spring extending through the high rate portion between the chamber divider and the inner piston.

8. A variable force tensioning assembly as set forth in claim 2 wherein the outer surface relief includes a plurality of ribs circumscribing the outer piston.

9. A variable force tensioning assembly as set forth in claim 8 wherein each of the plurality of ribs includes a shallow side and a steep side.

10. A variable force tensioning assembly as set forth in claim 9 including a ratchet clip slidably secured to the outer piston and slidable along the plurality of ribs rendering forces required to move the inner piston into the cylinder greater than forces required to move the inner piston out of the cylinder.

11. A variable force tensioning assembly as set forth in claim 10 including a retaining ring fixedly secured to the inner piston to secure the inner piston in spaced relation to the outer piston.

12. A variable force tensioning assembly for creating and maintaining a tension force on an endless loop used to transmit power, the variable force tensioning assembly comprising:
a body having a cylinder defining a cylinder inner diameter;
an outer piston disposed substantially within the cylinder and slidable therewithin, the outer piston including an outer piston tube and a chamber divider extending thorough the outer piston tube, the outer piston and the body defining a low rate portion;
an inner piston disposed at least partially within the outer piston tube and slidable therewithin, the inner piston defining a high rate portion and acting with the outer piston against the body to create a variable force to push against the endless loop to maintain a constant tension in the endless loop; and
a fluid inlet extending through the body and opening into the cylinder to provide fluid to the high rate chamber.

13. A variable force tensioning assembly as set forth in claim 12 including a check valve disposed inside the low rate chamber to inhibit fluid flow between the low and high rate chambers.

14. A variable force tensioning assembly as set forth in claim 13 wherein the chamber divider includes a chamber passage extending therethrough providing fluid communication between the high and low rate portions.

15. A variable force tensioning assembly as set forth in claim 14 including a low rate spring extending through the low rate portion between the body and the chamber divider.

16. A variable force tensioning assembly as set forth in claim 15 including a high rate spring extending through the high rate chamber between the chamber divider and the inner piston.

17. A variable force tensioning assembly for creating and maintaining a tension force on an endless loop used to transmit power, the variable force tensioning assembly comprising:
a body having a cylinder;
an outer piston disposed substantially within the cylinder and slidable therewithin, the outer piston including an outer piston tube and a chamber divider extending thorough the outer piston tube, the outer piston and the body defining a low rate portion, the outer piston tube including an outer surface relief including a plurality of ribs encircling the outer piston; and
an inner piston disposed at least partially within the outer piston tube and slidable therewithin, the inner piston defining a high rate portion and acting with the outer piston against the body to create a variable force to push against the endless loop to maintain a constant tension in the endless loop.

18. A variable force tensioning assembly as set forth in claim 17 wherein each of the plurality of ribs includes a shallow side and a steep side.

19. A variable force tensioning assembly as set forth in claim 18 including a ratchet clip slidably secured to the outer piston and slidable along the plurality of ribs rendering forces required to move the inner piston into the cylinder greater than forces required to move the inner piston out of the cylinder.

20. A variable force tensioning assembly as set forth in claim 19 including a retaining ring fixedly secured to the inner piston to secure the inner piston in spaced relation to the outer piston.
